(19) United States
(12) Patent Application Publication
(10) Pub. No.: US 2016/0161454 A1
(43) Pub. Date: Jun. 9, 2016

(54) HIGH RESOLUTION ANALYTE RECOVERY SYSTEM AND METHOD

(71) Applicants: Gregory Steven Jones, (US); Clemson University, Clemson, SC (US)

(72) Inventors: Gregory Steven Jones, Upton, MA (US); Feng Chen, Central, SC (US)

(21) Appl. No.: 14/960,773

(22) Filed: Dec. 7, 2015

Related U.S. Application Data
(60) Provisional application No. 62/088,929, filed on Dec. 8, 2014.

(51) Int. Cl. G01N 30/62; B01D 15/40; B01D 15/18; B01D 15/24; B01D 11/04

(52) U.S. Cl. CPC G01N 30/62; B01D 15/245; B01D 11/04; B01D 15/1885; B01D 15/40; G01N 2030/027

(57) ABSTRACT

Analyte separation systems for use in conjunction with chromatography separation devices and techniques are described. Disclosed systems include modular components that can provide for individualized design of separation schemes to better fit the needs of the user. In addition, the systems can be automated for efficient use of time. The system can include a mixing module for combination of fractions with an agent that can improve the recovery of the analyte from the fraction. Other modules can remove materials from the fluid flow through the system as waste or for recapture. Additional modules can be combined so as to provide parallel processing of multiple streams, which can further improve efficiency of the system.

### CROSS REFERENCE TO RELATED APPLICATION

This application claims filing benefit of U.S. Provisional Application Ser. No. 62/088,929, confirmation number 1058, having a filing date of Dec. 8, 2014, which is incorporated herein by reference in its entirety.

### BACKGROUND

Liquid chromatography has been utilized for many years to separate analytes within a sample mixture, to identify analytes, as well as to quantify analytes. High pressure liquid chromatography utilizes pumps to send a pressurized liquid stream containing the sample mixture through a separation column. Components in the sample interact differently with the column material and solvent, causing different retention times for the different components and leading to the separation of the components as they elute from the column and form separated fractions. A liquid chromatography column can utilize various separation modes such as normal phase, reversed-phase, ion exchange, and size exclusion among others to form the separated fractions from the initial injected mixture.

A one-dimensional liquid chromatography scheme uses a single separation mode, and the separated fractions are collected post-separation. To improve separation, it has become common to incorporate a detector in the system to better recognize the separated fractions as they come off of the column. For instance, FIG. 1A and FIG. 1B illustrate prior art systems in which a sample is separated into different fractions on a chromatographic column 100 with a detector 110, 112 located downstream of the column 100. In the system of FIG. 1A, the detector 110 is non-destructive (e.g., optical or UV detectors, conductivity detectors, fluorescence detectors, refractive index detectors, etc.) and thus can be placed in-line between the column 100 and a multi-outlet valve 114. The flow 10 including the different fractions can be separated at the valve 114 and collected as F₁, F₂, F₃, etc. FIG. 1B illustrates a similar system but utilizes a destructive detector 112 (e.g., mass spectrometer, flame ionization detector, evaporative light scattering detector, etc.) In this system the flow 10 out of the column is split from that going through the detector, but as both flow rates and tubing void volumes are known, the detector results can still be utilized at the valve 114 to separate the fractions for collection as F₁, F₂, F₃, etc.

It is sometimes difficult to analyze a sample with a one-dimensional liquid chromatography scheme. For example, when separating a biological sample via liquid chromatography in a one-dimensional separation mode, a large number of similar components are often present, leading to detection of overlapping fractions of the components even when a mass spectrometer with high resolution is used as a detector.

In order to solve this problem, multidimensional liquid chromatography has been developed. In multidimensional liquid chromatography, two or more different separation techniques are carried out sequentially, e.g., ion exchange followed by reversed-phase separation. Unfortunately, traditional multidimensional separations often require different mobile phase compositions in the differing stages of purification and as such, exchanging the mobile phase between separations may require a great deal of time and materials. The incorporation of trapping columns into high performance liquid chromatography (HPLC) systems has alleviated some of these issues. In a trapping system, after a fraction comes off of the first-dimension column, the analyte of the fraction is retained in a trap column, and then the component is eluted off of the trap column and processed by the next dimension separation column.

While such modifications and variations have provided improvement in the art, room for further improvement exists. For instance, existing systems still utilize extremely large volumes of expensive solvents. In addition, sample recovery with high resolution and in high concentration remains difficult. Therefore, extremely large volumes of collected fractions must be processed to recover a relatively small sample weight, particularly when considering the recovery of analytes that are present may be in very small amounts to begin with.

What are needed in the art are separation systems for use in liquid chromatography schemes that can provide analytes in a high concentration and with high resolution. In addition, what are needed are methods and systems that can provide recovered analytes from chromatographic separation techniques in shorter time periods and with higher purities while decreasing the number of steps needed to purify and recover target analytes resulting in cost savings benefits. Separation systems that are scalable and flexible so as to be modified as desired for each use would also be of great benefit.

### SUMMARY

Aspects and advantages of the invention will be set forth in part in the following description, or may be obvious from the description, or may be learned through practice of the invention.

In one embodiment disclosed herein is a modular analyte extraction system. The system can include a mixing module that is removably connectable downstream of a chromatography column. The mixing module includes a first inlet through which a fraction can flow from the chromatography column and into the mixing module and a second inlet through which a fraction modification agent can flow into the mixing module. The fraction modification agent can be any agent that can improve the selectivity and/or the resolution of a downstream trap for extraction of a targeted analyte in the fraction. The fraction and the fraction modification agent can be combined within the mixing module. The mixing module can also include an outlet through which this mixture can flow.

The system can also include a guidance module that can include one or more valves, e.g., one or more multi-position multi-outlet valves. The guidance module can be removably connectable downstream of the mixing module. The system can also include a plurality of analyte traps removably connectable downstream of the guidance module. The system may include multi-position multi-port valves which may be used to control the direction of the flow across the trapping columns. Each of the analyte traps can be removably connectable downstream of an outlet of a valve of the guidance module.

The system can include additional modules that can provide added benefits to the system. For instance, the system can include recycle and/or waste module(s) that can be removably connected between the chromatography column and the guidance module and either upstream or downstream of the mixing module. These modules can be used to divert a portion of a liquid solvent stream prior to sending the stream through the traps. A recycle module can be used to recover useful solvent, which can provide operational cost savings. Recycle and/or waste modules can also decrease the consumption of the fraction modification stream while successfully recovering the analyte fractions from the purified process stream.

The system can include additional modules that can provide control for the direction of flow across trapping columns as well as a route for simultaneous processing of multiple streams in parallel. For instance, the system can include additional guidance modules that can be removably connectable in parallel with one another and upstream of a series of analyte traps. Using the parallel guidance modules, multiple streams can simultaneously carry out analyte trapping, analyte eluting, trap rinsing, or other useful functions to improve the efficiency of the system.

Also disclosed are methods for using the disclosed systems. For instance, a detector that is either in line with or parallel to an outlet flow from a chromatography column can be in communication via a control system with the mixing module and the guidance module(s). An analyte stream containing sequential separated fractions can pass from the chromatography column to be examined at the detector, and the detector can recognize a first fraction and communicate the presence of that first fraction to the control system. The control system can communicate with a pump or other suitable component of the mixing module so as to control the flow of a first fraction modification agent to be combined with the analyte stream and likewise control the mobile phase (solvent) concentration of the first fraction in the analyte stream. By use of the control system, the fraction modification agent can be combined with the first fraction at the mixing module to form a mixture. This mixture (including the first fraction combined with the first fraction modification agent) can then pass to a guidance module. The control system can direct the flow of the first fraction at this guidance module to a first analyte trap, where the targeted analyte can be extracted from the fraction as it flows through the trap, for instance via adsorption chromatography or solid phase extraction. Subsequent fractions can be likewise directed via the control system, and multiple analytes can be extracted from the solution and recovered with high resolution and in high concentration.

These and other features, aspects and advantages of the present disclosure will become better understood with reference to the following description and appended claims.

### BRIEF DESCRIPTION OF THE FIGURES

A full and enabling disclosure of the present invention, including the best mode thereof, directed to one of ordinary skill in the art, is set forth in the specification, which makes reference to the appended figures, in which:

FIG. 1A illustrates a prior art liquid chromatography system including a separation column, a non-destructive detector, and a multi-outlet valve for separation of multiple fractions from a sample.

FIG. 1B illustrates a prior art liquid chromatography system including a separation column, a destructive detector, and a multi-outlet valve for separation of multiple fractions from a sample.

FIG. 2 illustrates components of a system as disclosed herein including a mixing module upstream of a guidance module that includes a fraction separating multi-outlet valve.

FIG. 3 illustrates a system as disclosed herein including a combined waste/recycle module.

FIG. 4 illustrates a system as disclosed herein including a waste module and a recycle module.

FIG. 5 illustrates a system as disclosed herein including an analyte stream and a parallel processing stream.

FIG. 6 illustrates a system as disclosed herein including an analyte stream and two parallel processing streams.

FIG. 7 illustrates a system as disclosed herein including two parallel liquid chromatography analyte streams that can each carry purified fractions, these parallel analyte streams being in conjunction with multiple parallel processing streams.

FIG. 8 illustrates a downstream process for elution of trapped fraction analytes prior to introduction into an additional liquid chromatography dimensional module as may be incorporated in a system.

Repeat use of reference characters throughout the present specification and appended drawings is intended to represent same or analogous features or elements of the invention.

### DETAILED DESCRIPTION

It is to be understood by one of ordinary skill in the art that the present discussion is a description of exemplary embodiments only, and is not intended as limiting the broader aspects of the present disclosure. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

The present disclosure is generally directed to separation systems for use in conjunction with liquid or supercritical fluid chromatography separation devices and techniques. Disclosed systems include modular components that can provide for individualized design of separation schemes to better fit the needs of the user. In addition, the systems can be fully automated for efficient use of time, improved operator safety, increased purity through incorporation with detection, and decreased cross contamination that can occur in an off-line system.

Modules of the system can be utilized to improve the total recovery of targeted analytes while simultaneously decreasing the amount of time required to obtain recovery and increasing selectivity of recovery. In addition, modules can be included that can remove solvent from the fluid flow through the system prior to trapping the targeted analytes. This feature can not only increase throughput and recovery of analytes, but also can be used to recover solvent, further decreasing costs. Moreover, modules can be combined so as to provide parallel processing of multiple streams, which can further improve efficiency of the system.

As all components of a system can be provided as removably connectable modules, every separation and recovery process can be individualized for desirable flow rates, pressure differentials, instrumentation, and the like. For instance, separation columns, analyte traps, mixers, valves, pumps, and even tubing can be individually sized, selected and combined so as to recover the targeted analytes in the highest possible amounts, for instance from nanograms to grams, depending upon the purification scale and analyte characteristics of the sample.

Moreover, the disclosed systems can be utilized with any known chromatography components including separation columns, detectors, and analyte traps. Accordingly, separation and recovery schemes can mix and match separation devices, detectors, and analyte traps in both single and multi-dimensional schemes to improve recovery of the desired analytes with regard to both purity and concentration. For instance, different types of analyte traps can be utilized in parallel and/or in sequential arrangements and the multiple analyte traps can be modified as desired by use of the modular system to meet the demands of any separation scheme and thus to maximize analyte recovery.

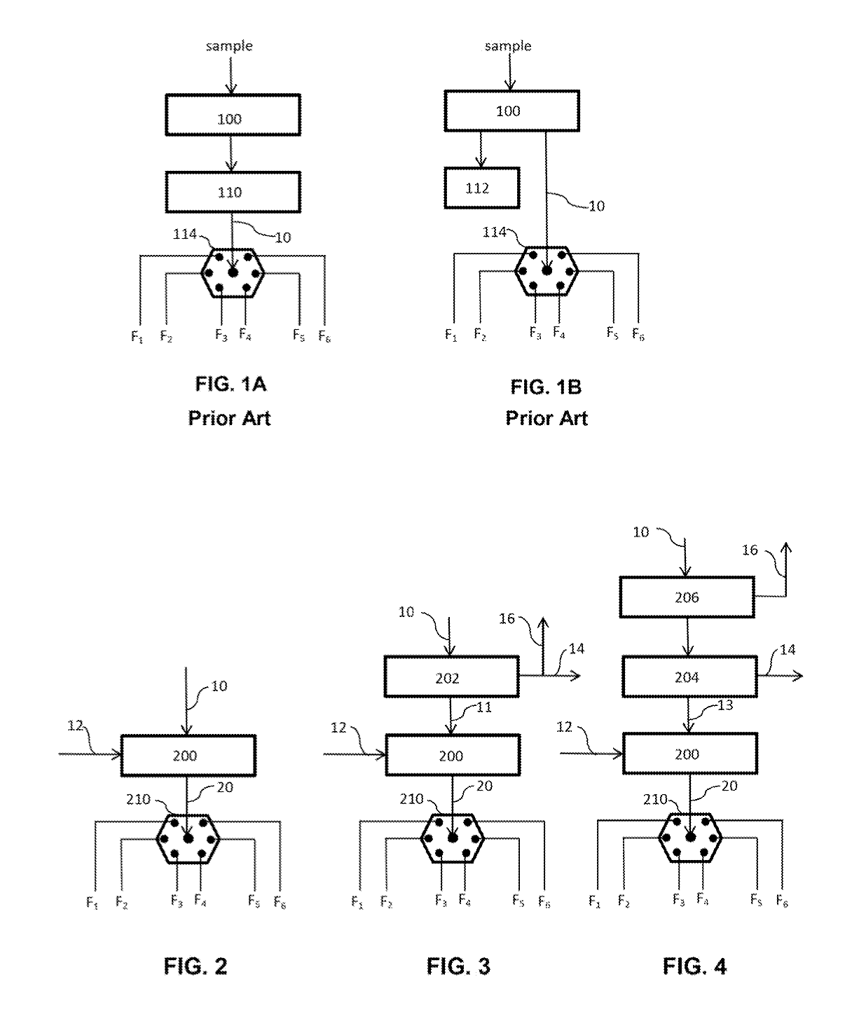

One module of a separation system can be a mixing module. As illustrated in FIG. 2, a mixing module 200 can include a first inlet 10 and a second inlet 12. The first inlet 10 can be downstream of a liquid chromatography scheme as is known in the art, for instance a scheme as illustrated in FIG. 1A or FIG. 1B.

Any liquid or supercritical fluid chromatography separation device and method can be utilized to provide the inlet flow 10 to the mixing module 200. For instance, an upstream chromatography separation as illustrated in FIG. 1A or FIG. 1B can be upstream of a mixing module 200. In addition, the upstream chromatography separation can be a single-dimension separation or a multi-dimensional separation as is known. For instance, a two dimensional HPLC system can be upstream of the mixing module 200 and provide the analyte stream via inlet flow 10 to the system.

A chromatography separation module that is upstream of a mixing module 200 can function according to any known separation scheme including a normal phase separation, a reversed-phase separation, ion exchange separation, a size exclusion separation, or any other separation scheme or combinations thereof that can provide an analyte stream via inlet flow 10 in which components of the sample are physically separated along the flow path through interaction of the sample components with the separation module.

In general, a separation module (e.g., separation module 100 of FIG. 1A or FIG. 1B) can include a solid phase support with or without a modified surface that can interact with the sample components so as to alter retention of the subcomponents through the chromatography module and separate the fractions based on various retention mechanisms (i.e. adsorption). The solid phase can be in any form including, without limitation, fully- and superficially-porous spherical particles, beads, fibers, hollow fibers, or the like. In one embodiment, the solid phase can be porous and/or hollow and the pores or hollow portions can include a second phase for interaction with the sample. In one embodiment, the separation module can include channeled fibers, for instance as described in U.S. Pat. No. 7,261,813 to Marcus, et al., which is incorporated herein by reference. The channeled polymer fiber solid phase system can be useful in some embodiments as it can operate at a very low back pressure while a high linear velocity is used.

The system can also incorporate a detector as is generally known in the art upstream of the mixing module 200. For instance, the system can incorporate either a non-destructive detection module 110 or a destructive detection module 112 as illustrated in FIG. 1A and FIG. 1B. Non-destructive detectors as may be used can include, without limitation, UV detectors (including fixed or variable wavelength detectors including diode array detectors), fluorescence-based detectors, conductivity monitors, refractive index detectors, radio flow detectors, chiral detectors, as well as combinations of non-destructive detectors. Destructive detectors as may be used can include, without limitation, aerosol-based detectors, atomic-emission detectors, evaporative light scattering detectors, and mass spectrometers, as well as combinations of destructive detectors. Of course, combinations of destructive and non-destructive detectors may also be utilized.

Following formation of the fractions, the analyte stream including the separated fractions can proceed via inlet flow 10 to a mixing module 200 (FIG. 2). At the mixing module 200 a fraction modification agent can be provided as at 12 and combined with the flow 10. The mixing module can incorporate any suitable combination scheme, for instance a simple T-union or a more thorough mixer such as a static or dynamic mixer. In addition, modules of the disclosed systems, for instance the mixing module 200, can include pumps, piping, valves, electronic communication ports and devices, etc. as necessary. In particular, the mixing module 200 can include multiple components in conjunction with a mixing device that can provide for the combination of one or more fractions of the analyte stream with fraction modification agent(s) as described.

Through control of the flow rate of the inlet flow 10 and knowledge of each fraction exit time from the upstream chromatography column, which may be triggered by a detector or determined by any other suitable means, the addition of a fraction modification agent can be controlled in order that each fraction contained in the inlet flow 10 is sequentially combined with a predetermined fraction modification agent or, depending on the nature of the individual fraction and the desired purification protocol, with no fraction modification agent.

The fraction modification agent can be provided to the mixing module 200 via an inlet 12. The fraction modification agent can be any compound or combination of compounds that can improve purification/separation of a targeted analyte that is contained in the analyte stream. For instance, the fraction modification agent can be a pH modifier that modifies the pH of the analyte stream portion with which it is combined, leading to improved separation of the targeted analyte from the analyte stream at the downstream trap. In another embodiment, the fraction modification agent can interact directly with the analyte. For instance, the fraction modification agent can react with the analyte to form a reactive functionality on the analyte that interacts with a binding agent in a downstream trap.

In general, the fraction modification agent can be provided as a liquid via inlet flow 12. The fraction modification agent can be a liquid or a component of a liquid that when combined with a fraction of the analyte stream can provide for the improved extraction and recovery of an analyte contained in the fraction. More specifically, recovery of the targeted analyte from the mixture including the fraction modification agent combined with the carrier liquid of the inlet flow 10 can be improved as compared to recovery of the targeted analyte from carrier liquid of the inlet flow 10 alone.

The liquid containing the fraction modification agent (inlet flow 12) and the carrier liquid containing a targeted analyte (inlet flow 10) can be miscible or immiscible, as desired. For instance, in one embodiment the fraction modification agent can be or can be carried by an aqueous solvent and the carrier liquid of inlet flow 10 can be an organic solvent. In such an embodiment, the analyte may preferentially partition to the aqueous phase from the organic phase following formation of the mixture at the mixing module 200, which can improve extraction and recovery of the analyte at a downstream trap.

The mixing module, e.g., a mixing module including a static mixer, can improve the homogeneity of the solvent and analyte mixture system and can encourage improved recovery on an analyte trap. For instance, the analyte can be extracted and recovered on a downstream trap according to a solid-liquid extraction scheme from the combined mixture that includes the initial carrier liquid of the inlet flow 10 and the fraction modification agent liquid of the inlet flow 12.

Following modification of the fraction at the mixing module 200, the mixture thus formed can flow to a downstream guidance module 210 that includes a multi-outlet valve. At the guidance module 210, individual fractions of the analyte stream can be separated by switching the outlet route and forming separate fractions F₁, F₂, F₃, etc. as shown. Though illustrated as a six outlet valve in the figures, it should be understood that a valve of any suitable size and dimensions can be utilized in the system. Moreover, though illustrated as containing six different fractions, it will be understood that the number of fractions coming off of the chromatography column will vary, and it is not necessary to use all of the outlets of any particular valve. Moreover, multiple valves can be utilized in parallel in those embodiments in which a sample includes more fractions than can be directed with a single valve. For instance, in an embodiment in which a sample includes more than six different fractions, a plurality of multi-outlet valves may be utilized in parallel in a single guidance module instead of a single multi-outlet valve guidance module 210 as illustrated in FIG. 2. Moreover, valves of different sizes and capabilities can be combined as desired. Such modifications are well within the abilities of one of ordinary skill in the art.

In one embodiment, the system can incorporate one or more multi-position, multi-port valves as are known in the art. Incorporating a multi-position multi-port valve can be utilized in one embodiment to change the direction of flow across the trapping column. This action may facilitate a popular technique known as back flush elution in which the analytes trapped on the head of the column may be eluted while minimizing dispersion effects of the analyte on the trapping column and minimizing the dilution effect of the trapped analytes due to the elution solvent volume.

Beneficially, the system can be automated by use of a control system. For instance, the system may further include a controller (e.g., a PLC controller) that is configured to operate valves of the guidance module 210 and control the flow of fraction modification agents provided at 12. For instance, inlet flow 12 can be in fluid communication with a plurality of different fraction modification agents, and the controller can be utilized to provide a different fraction modification agent at the mixing module 200 via inlet flow 12 depending upon the particular analyte contained in the fraction with which the modification agent is to be combined. The controller may also be in communication with an upstream detector and/or chromatography column, for instance to control flow rate of the fractions to the mixing module 200 via line 10.

A controller may include one or more memory devices and one or more microprocessors, such as general or special purpose microprocessors operable to execute programming instructions or micro-control code associated with modules of the system. For instance, a controller may execute instructions affecting the solvent composition, flow rate, etc. at chromatography separation module 100, operation parameters of detection modules 110, 112 (FIG. 1A, FIG. 1B), fraction modification agent delivery at mixing module 200, outlet valve selection at guidance module 210 (FIG. 2), and so forth. The memory may represent random access memory such as DRAM, or read only memory such as ROM or FLASH. In one embodiment, the processor executes programming instructions stored in memory. The memory may be a separate component from the processor or may be included onboard within the processor.

A controller may generally serve to modulate flow through the modules such as through mixing module 200 via inlet 10, inlet 12, and outlet 20 as desired. Further, the system may include a user interface panel as is known in the art. In one embodiment, the user interface panel may represent a general purpose I/O (“GPIO”) device or functional block. In one embodiment, the user interface may include one or more user inputs, such as one or more of a variety of electrical, mechanical or electro-mechanical input devices including rotary dials, push buttons, and touch pads. The user interface panel may additionally include a display component, such as a digital or analog display device designed to provide operational feedback to a user. The user interface panel, and the user inputs and display component thereof, may be in communication with the controller, such as via one or more signal lines or shared communication busses. The user interface panel, and the user inputs and display component thereof, may allow a user to select various operational features and modes and monitor progress of the system generally. For example, the user inputs allow a user to select the fraction modification agent provided at flow inlet 12 and the coordination of the outlet (F₁, F₂, F₃, etc.) utilized at the guidance module 210 via a recognized signal at the detection module 110, 112 for various operations as desired.

The modular system can include additional modules in conjunction with the mixing module. For instance, in the embodiment illustrated in FIG. 3, the system can include a combined waste/recycle module 202. The waste/recycle module can be utilized to remove materials from the sample flow following separation at a chromatography column. Though illustrated as upstream of the mixing module 200, this is not a requirement, and a waste/recycle module 202 can alternatively be located downstream of the mixing module 200 though generally still upstream of the guidance module 210. The waste/recycle stream can be in communication with the control system (or can be manually controlled) for removal of a portion of the flow prior to the analyte collection. For instance, through communication with the detection module, a control system can pull off solvent for recycle 16 between sequential fractions. This solvent can be recycled as at 16 or saved and refurbished for future use. Similarly, if there is a fraction in the inlet flow 10 from the separation module 100 that is of no use or interest, a fraction can be removed from the flow stream 10 and sent to waste as at 14. The selection between recycle 16 and waste 14 can be carried out by use of a multi-outlet valve that can be a component of the combined waste/recycle module 202.

In another embodiment, illustrated in FIG. 4, a separate recycle module 206 and waste module 204 can be included in the system. In this embodiment, the recycle module 206 can be utilized to divert recoverable solvent 16 from the analyte stream and this module can be upstream of the waste module 204 that can be utilized to divert waste flow 14 from the analyte stream. This particular order of the recycle and waste modules 206, 204 is not a requirement, however, and as with a single combined waste/recycle module 202, the particular location of each module in the system is not a requirement, and modules can be located in any order as desired downstream of the chromatography column. This modular aspect of the system allows the specific design to be modified to best fit the needs of the particular separation that is being carried out.

Removal of extraneous non-recoverable material and/or recoverable solvent from the stream prior to diversion of the fractions to individual collection traps can increase the purity and minimize the number of trapping columns attached to the modules without introducing undesired compounds to the trapping columns. In addition, this can allow for recovery and reuse of solvent, which can provide cost savings to the system.

Following separation at the guidance module 210, the separated fractions can be collected as desired. For instance, in one embodiment, the separated fractions can be directed to traps for extraction of analytes contained in the fractions. Any suitable trapping system can be included in disclosed systems, with preferred trapping materials and parameters generally depending on the nature of the analyte to be captured. For instance, an adsorption chromatography or solid-liquid extraction column that has been packed with a stationary phase whose surface is modified with a binding agent or functional group for recovering a targeted analyte can be utilized to extract and recover the targeted analyte from the solvent separated fraction.

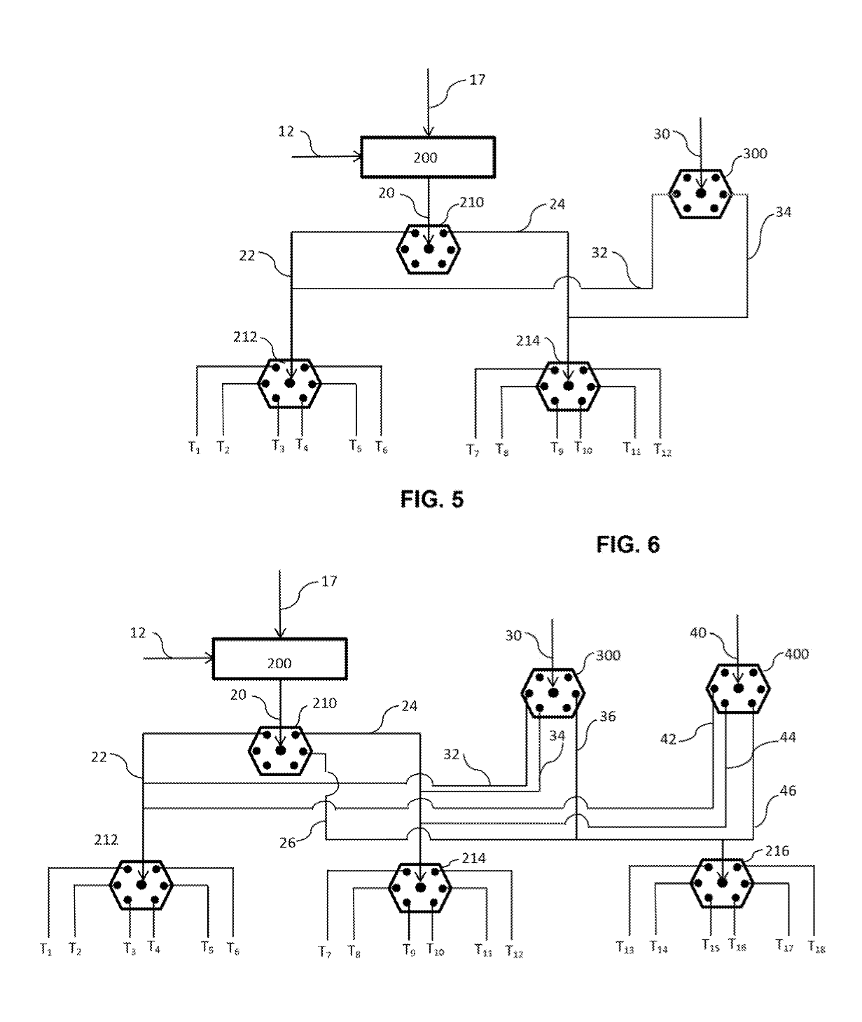

The modular extraction system can include additional modules that can provide a route to parallel processing of fractions of one or more analyte streams, which can provide significant time and cost savings to a purification process. For example, as illustrated in FIG. 5, a system can include a processing stream 30 that can be routed through guidance module 300 that can include a multi-outlet valve. Processing stream 30 provided to guidance module 300 can include one or more processing aids for use in the purification system. For example, processing stream 30 can include an eluent for removing a purified analyte from a trap (e.g., traps T₁-T₁₂) that is downstream of the guidance module 300. In one embodiment, processing stream 30 can include a wash fluid that can be utilized to rinse and clean a downstream trap following elution of an analyte off of the trap. Materials as may be provided via processing stream 30 can include any component that can beneficially affect the separation, purification, recovery, etc. of an analyte contained in an analyte stream. For instance a desalting solution may be provided via processing stream 30 in order that a desalting treatment or buffer exchange can be carried out in one or more downstream traps T₁-T₁₂.

Processing stream 30 can optionally carry multiple solvents and/or solutions for use in the purification system, either in conjunction with one another or sequentially, as desired. For instance, processing stream 30 can be utilized to carry one or more eluents to each of the traps T₁-T₁₂ and, following elution of the analytes off of the traps, the processing stream 30 can be utilized to carry a rinse solution to each of the traps.

In any case, the guidance module 300 can be removably connectable to the system such that outlets 32, 34 from the guidance module 300 are in fluid communication with outlets 22, 24 of the guidance module 210. Of course, the number of lines out of any particular guidance module can vary depending upon the number of fractions in the analyte stream 17 coming into the mixing module 200 as well as the number and types of compounds of processing stream 30 to be directed by guidance module 300. By way of example, the guidance module 300 can be utilized to sequentially provide multiple different processing materials to one or more of the downstream traps T₁-T₁₂ via multi-outlet valve(s). The different processing materials can be included in the process stream 30 either in conjunction with one another or sequentially, as desired, and the guidance module 300 need not provide only a single type of processing material to the downstream traps.

As illustrated, the guidance module 210 and the guidance module 300 can be parallel to one another in the system and the guidance module 210 can be downstream of the mixing module 200, as shown. In addition, the guidance module 210 and the guidance module 300 can be in fluid communication and upstream of guidance module 212 and guidance module 214, each of which can be utilized to direct the separated fractions contained in the analyte stream 17 and the processing stream 30 to the traps T₁-T₁₂. During use, a plurality of fractions contained in analyte stream 17 can be sequentially directed through guidance module 210 following optional combination with a fraction modification agent at mixing module 200. A first series of these fractions can flow via line 22 to guidance module 212, where they can be separated for collection on traps T₁-T₆. Simultaneously, a processing aid contained in processing stream 30 can be provided via outlet 34 from guidance module 300 to guidance module 214 and then to each of traps T₇-T₁₂ in turn.

For example, via guidance modules 300 and 214, the outlet 34 can carry a processing aid (e.g., an eluent) to trap T₇ that has previously been utilized to trap a targeted analyte of analyte stream 17. At the same time as trap T₇ is being eluted, the outlet 22 can carry a different fraction of analyte stream 17 to trap T₁ via guidance modules 210 and 212. Additional fractions of analyte stream 17 can be sequentially guided via guidance module 212 to T₂, T₃, T₄, T₅ and T₆. As these traps are capturing each fraction, processing stream 30 can be sequentially guided via guidance module 214 to T₇, T₈, T₉, T₁₀, T₁₁, and T₁₂. After the final fraction to be guided to the first series of traps T₁-T₆ has passed through the guidance module 212, the outflow from guidance module 210 can be switched to line 24, and a second series of fractions can be guided via line 24 and guidance modules 210 and 214 through the second series of traps T₇-T₁₂. Simultaneously, the process stream 30 can be directed via line 32 and guidance modules 300 and 212 to interact with the first series of traps T₁-T₆. The parallel, simultaneous trapping and processing of fractions contained in the analyte stream 17 can greatly increase the efficiency of a system and thus save both time and money.

Additional modules can be added to the system to further improve efficiency of the system. For instance, as illustrated in FIG. 6, a second processing stream 40 can be directed via a guidance module 400. The processing stream 40 from guidance module 400 can be sequentially directed to a third series of traps T₁₃-T₁₈ at the same time that fractions contained in the analyte stream 17 are being sequentially directed to traps T₁-T₆ and at the same time that a processing stream 30 from guidance module 300 is being sequentially directed to traps T₇-T₁₂. For instance, as a first series of traps T₁-T₆ can be sequentially trapping analytes contained in sequential fractions of the analyte stream 17, a second series of traps T₇-T₁₂ can be sequentially subjected to a processing stream 30 (e.g., containing an eluent) from the guidance module 300 (with the compound carried to each trap T₇-T₁₂ being the same or different from one another, as desired), and a third series of traps T₁₃-T₁₈ can be sequentially subjected to a processing stream 40 (e.g., containing a trap rinse) from the guidance module 400.

By way of example at the same time that traps T₁₃-T₁₈ are immobilizing analytes via adsorption to the stationary phase as part of a solid-liquid extraction scheme, previously captured analytes can be eluted off of traps T₇-T₁₂ and traps T₁-T₆ can be cleaned, reconditioned, and re-equilibrated.

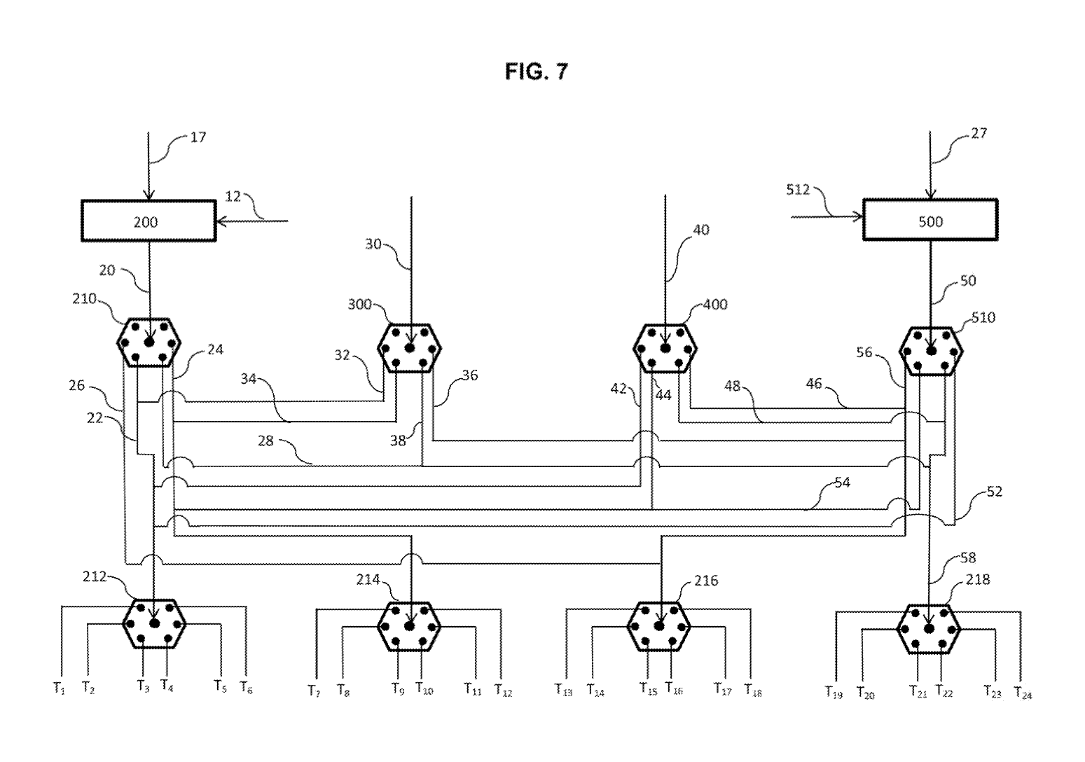

FIG. 7 illustrates another embodiment of a modular system that can incorporate a second, parallel separation column. For example, an analyte stream 27 can be in fluid communication with one or more upstream chromatographic separation modules, and downstream or parallel to a detector as discussed above. The analyte stream 27 can carry sequential fractions from the upstream separation module to a mixing module 500 where each fraction can be combined as desired with a fraction modification agent. Downstream of the mixing module 500, each fraction contained in the mixture 50 can be directed via lines 52, 54, 56, and 58 and guidance modules 510, 212, 214, 216, and 218 to one of traps T₁-T₂₄.

Simultaneously, sequential fractions contained in analytes stream 17 can be combined with fraction modification agent(s) 12 at mixing module 200 and directed via lines 22, 24, 26, and 28 and guidance modules 210, 212, 214, 216, 218 to one of traps T₁-T₂₄.

Additionally, the system can include processing stream 30 and processing stream 40 that can be guided via lines 32, 34, 36, and 38 or lines 42, 44, 46, and 48 respectively as well as guidance modules 300, 400 respectively and via guidance modules 212, 214, 216, 218 to one of the traps T₁-T₂₄. For instance, as a first series of fractions contained in analyte stream 17 are guided to and trapped within one of traps T₁-T₆, a second series of fractions contained in analyte stream 27 can be guided to and trapped within one of traps T₁₉-T₂₄. At the same time, processing stream 30 can be delivering one or more useful processing aids (e.g., eluents) sequentially to traps T₇-T₁₂ and processing stream 40 can be delivering one or more useful processing aids (e.g., desalting solutions) sequentially to traps T₁₃-T₁₈.

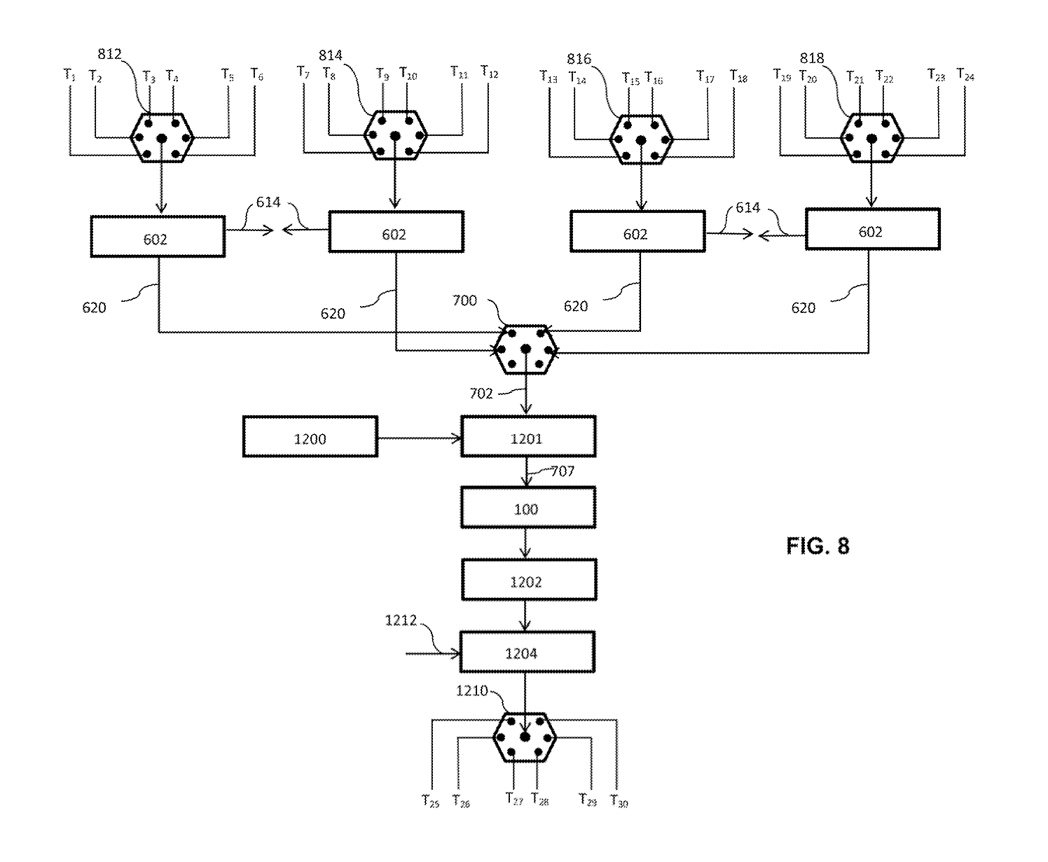

Additional modules can be included in the system as desired and, due to the modular capability of the system the system can be specifically designed for each application so as to function in the most efficient manner possible. For instance, in one embodiment, the modular system can be designed to include a two- dimensional separation scheme. For instance, as illustrated in FIG. 8, following separation into a first series of traps T₁-T₂₄ as discussed above, one or more of the first dimension traps can be subjected to a second purification and separation process.

For instance, in the illustrated embodiment, each trap T₁-T₂₄ can be up stream of a guidance module 812, 814, 816, 818. Upon elution of an analyte (or combination of analytes) off of a trap (e.g., T₁), the guidance module (e.g., 812) can direct the eluted flow containing the analyte to a waste/recycle module 602 where waste/recycle flow 614 can be diverted. Analyte-containing eluted streams 620 can then deliver the eluted analytes from the original traps T₁-T₂₄ to a guidance module 700. Of course, more than one guidance module may be utilized for such downstream processing. For instance, each waste/recycle module 602 can be in fluid communication with a different guidance module 700 or can be in communication with multiple guidance modules 700. Again, the modular nature of the separation system allows for any desired module design to be employed.

The guidance module 700 can sequentially deliver each analyte carried in eluent stream 702 to an injection module 1201. At the injection/mixing module 1201, each analyte (or group of analytes) from the first set of upstream traps can be introduced into a downstream purification process by diverting the flow of the eluted analyte (or group of analytes) from the upstream trap into a downstream analyte purification stream. This downstream purification stream introduces the trapped analyte (or groups of analytes) from the upstream traps into a solvent system that can be provided from solvent module 1200. Specifically, the eluted analyte can be combined with a solvent at the injection/mixing module 1201. The solvent to be combined with each subsequent analyte can be the same or different. For instance, a first series of analytes in eluent stream 702 can be combined with an aqueous solvent at injection module 1201 and a second series of analytes in eluent stream 702 can be combined with an organic solvent at injection module 1201. Similarly, different aqueous and/or organic solvents can be combined with different analytes.

The analyte (or combination of analytes), now carried in a solvent of choice as an analyte stream 707, can then be sent through a liquid chromatographic column 100 as is known in the art for further purification/separation. For instance, a further purification process can be carried out including recognition of sequential fractions by use of a detection module 1202 (which, as described above can include destructive detection, non-destructive detection, or combinations thereof), combination of one or more fractions with a fraction modification agent-containing liquid 1212 at a mixing module 1204, and trapping of the fractions at traps T₂₅-T₃₀ by use of a guidance module 1210.

For instance, at the mixing module 1204, each fraction can optionally be sequentially combined with a fraction modification agent (which can be the same or different for each fraction, as discussed above), and the mixed components can then be directed via a guidance module 1210 to a series of traps T₂₅-T₃₀. Analytes recovered in the initial trapping process can be subjected to an additional separation dimension sequentially as shown in FIG. 8 or in parallel, simultaneous dimensions, as desired and as discussed above.

The fraction modification techniques and parallel processing capabilities of the disclosed modular systems can greatly improve efficiency of recovery processes with regard to both time and costs. Automated control systems that can provide continuous processing capabilities as well as on-line modifications of flow-rates, pressure differentials, and the like can be utilized to further improve the disclosed systems. The capability to decrease the time required to dry down and/or concentrate large volumes of dilute samples in difficult to remove solvent systems is highlighted with the described systems. The automated and self-contained system can also decrease technician exposure to materials used in the systems, e.g., organic solvents that can emit volatile organic compounds.

The time and materials savings possible by use of the system can make it beneficial for use in both manufacturing and research applications. For instance, manufacturing technologies involved in the production of pharmaceuticals, nutraceuticals (e.g., dietary supplements), and high value added chemicals (chiral materials, standards materials, etc.) can be manufactured in a more efficient manner by use of disclosed systems. In addition, research areas such as drug research, impurity assessment, and multidimensional chromatography can be more cost effective and efficient by use of the disclosed systems.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A modular analyte extraction system comprising:
a mixing module, the mixing module being removably connectable downstream of a chromatography separation column, the mixing module comprising a first inlet through which a fraction can flow from the chromatography separation column and into the mixing module, the mixing module comprising a second inlet through which a fraction modification agent can flow into the mixing module;
a first guidance module that is removably connectable downstream of the mixing module, the guidance module comprising one or more valves;
a plurality of analyte traps that are removably connectable downstream of the guidance module, each analyte trap being connectable in fluid communication with an outlet of the one or more valves.

2. The system of claim 1, further comprising a control system in communication with the mixing module and the first guidance module.

3. The system of claim 1, further comprising the chromatography separation column and a detector.

4. The system of claim 3, wherein the detector comprises a destructive detector and/or a non-destructive detector.

5. The system of claim 3, wherein the chromatography separation column is a liquid chromatography separation column or a supercritical fluid chromatography separation column.

6. The system of claim 1, further comprising a waste module and/or a recycle module that are removably connectable upstream of the guidance module.

7. The system of claim 1, further comprising one or more additional guidance modules removably connectable downstream of the first guidance module and upstream of the plurality of analyte traps.

8. The system of claim 7, further comprising a processing stream and a guidance module for the processing stream, the guidance module for the processing stream being removably connectable in parallel with the first guidance module and upstream of the one or more additional guidance modules.

9. The system of claim 1, further comprising a second mixing module that is removably connectable in parallel with the mixing module of claim 1, the second mixing module being removably connectable downstream of a second chromatography separation column.

10. The system of claim 1, further comprising an additional downstream dimension separation system that is removably connectable downstream of at least one of the analyte traps.

11. The system of claim 1, wherein the one or more valves comprise one or more multi-position multi-outlet valves.

12. A method of extracting an analyte from a sample comprising:
providing a sample containing the analyte to a chromatography column, the sample being separated into a flow comprising a series of fractions by use of the chromatography column, the analyte being contained within a first fraction;
directing the flow containing the first fraction to a mixing module that is downstream of the chromatography column;
combining the first fraction with a fraction modification agent at the mixing module to form a first mixture;
directing the first mixture from the mixing module to a first analyte trap; and
extracting the analyte from the first mixture at the analyte trap.

13. The method of claim 12, further comprising detecting the analyte in the fraction by use of a non-destructive or a destructive detector.

14. The method of claim 12, wherein the method is automatically controlled by use of a control system.

15. The method of claim 12, further comprising removing material from the flow prior to directing the first mixture to the first analyte trap.

16. The method of claim 15, wherein the material comprises a solvent, the method further comprising recovering the solvent.

17. The method of claim 12, further comprising sequentially directing each of the fractions contained in the series of fractions to a first series of analyte traps.

18. The method of claim 17, further comprising directing a first processing stream to a second series of analyte traps simultaneously as each of the fractions are directed to the first series of analyte traps.

19. The method of claim 18, further comprising directing a second processing stream to a third series of analyte traps simultaneously as each of the fractions are directed to the first series of analyte traps.

20. The method of claim 18, further comprising providing a second sample to a second chromatography column, the second chromatography column being operated in parallel with the chromatography column of claim 12.
